(19) United States
(12) Patent Application Publication
(10) Pub. No.: US 2013/0008390 A1
(43) Pub. Date: Jan. 10, 2013

(54) Electrode design for deer repellent device

(76) Inventor: Keith M. Betzen, Unionville, IN (US)

(21) Appl. No.: 13/135,426

(22) Filed: Jul. 5, 2011

(51) Int. Cl. A01K 15/00

(52) U.S. Cl. 119/712

(57) ABSTRACT

An improved electrode design is provided for a baited, shock-producing, deer repellent device deployed in an area to be protected. This device has straight, parallel, positive and negative, un-insulated metal electrodes extending vertically from the top. The electrodes are spaced and sized so that they surround and protect the bait. This electrode design increases the chance that a deer will make effective contact with the electrodes while also allowing easy access to the bait for servicing. This electrode design also decreases the chances of the device collecting ice or snow, and it decreases the chance of discharge of the device by moisture or by contact between the electrodes.

### BACKGROUND—FIELD

This application relates to animal repellent devices; it relates particularly to a baited, shock-producing deer repellent device having an improved electrode design.

### BACKGROUND—PRIOR ART

Various electrode designs have been described for shock-producing animal deterrent devices.

U.S. Pat. No. 922,377 to Ames (1909), French Patent 440,270 to Calvert (1912), and Swiss Patent 82,560 to Baumann (1919) show extermination devices for small animals with the electrodes being arranged essentially in the same plane.

U.S. Pat. No. 4,630,571 to Palmer (1986) shows an animal training device with the outer conductive case of the device being one electrode and the stake to the earth being the other.

U.S. Pat. No. 5,894,818 to Betzen (1999) describes a baited, shock-producing deer repellent device in which the electrodes are short projections above the top surface of the device.

An electrode design for use in a baited, shock-producing deer repellent device must surround the bait and protect the bait from being touched by the deer without first contacting the electrodes. If a deer touches the bait before contacting the electrodes, it will realize the bait is artificial, and the deer will then ignore the device, but it will not avoid the area to be protected where the devices are deployed.

None of these prior art devices provides an electrode design that surrounds the bait and protects it from an approach from the top and sides.

U.S. Pat. No. 6,014,951 to Betzen (2000) describes a baited, shock-producing deer repellent device with two circular, crisscrossing electrodes. With this design the distance between the electrodes varies widely..The very small distance between the electrodes at the crossing point causes the device to be easily discharged by a drop of water or by contact between the electrodes with even the slightest distortion. The very short circuit path at this top point may result in a greatly diminished effect on the deer, or the device might be completely discharged by the deer's saliva with no effect at all on the deer. On the other hand, the relatively very large distance between the electrodes at the sides of this device results in a decreased chance that the deer will contact two electrodes simultaneously. Using this design, the optimal distance between the electrodes cannot be maintained, resulting in an increased possibility that the deer will not effectively contact the electrodes and receive a shock. Also, these crisscrossing electrodes block easy access to the bait in the center of the electrodes, making it difficult to service the bait, and the horizontal aspect at the top of these electrodes tends to collect snow and ice and discharge the device.

Woodstream Corp., Lititz, Pa., manufactures a baited, shock-producing deer repellent device called the Havahart Electronic Repellent for Deer, which has two sets of semi-circular, crisscrossing electrodes. This design has all of the disadvantages of the device described by Betzen (2000), but it has an even greater chance of contact between the electrodes with distortion of the wires or by droplets of water because there are four crossing points. Also, this electrode design has an increased chance for ice and snow accumulation.

U.S. Pat. No. 6,550,428 to Betzen (2003) describes a baited, shock-producing deer repellent device with a series of parallel semicircular, electrodes arranged and sized to form an approximate hemisphere to surround the bait. While this design eliminates the crossing points, the horizontal aspect of these multiple electrodes block access to the center making it difficult to service the bait and increases the chance for accumulation of snow and ice on the device.

U.S. Pat. No. 6,779,490 to Betzen (2004) describes a baited, shock-producing deer repellent device with an insulator to keep the circular electrodes from contacting each other at the crossing point. With this insulator the distance between the electrodes at the crossing point remains very small, and moisture will discharge the device as it covers the surface of the insulator. This insulator increases the chance for snow and ice accumulation on top of the device and further blocks access to the center of the electrodes for servicing the bait. Also, this insulator further decreases chances of the deer making effective contact with the electrodes at the top of the device.

Therefore it can be seen that all of the prior art devices disclosed herein suffer from disadvantages that limit their effectiveness.

An electrode design for a baited, shock-producing deer repellent device should surround and protect the bait from an approach from the top and sides and provide a maximum chance that the deer will effectively contact the electrodes. The electrodes should have a uniform optimal distance between them to provide an ample and consistent circuit path while being close enough to facilitate effective contact with the deer. The electrodes should allow easy access to their center for servicing the bait. The electrodes should tend not to collect snow and ice. Droplets of water or a coating of water should not easily cause electrical conduction between the electrodes and discharge the device. None of the prior art provides such an electrode design.

### SUMMARY

In accordance with one embodiment, an electrode design comprises un-insulated metal electrodes that are straight, arranged vertically and spaced and sized to surround the bait.

Features of an embodiment of an improved electrode design for a deer repellent device will become apparent from a consideration of the ensuing drawings and description.

DRAWINGS

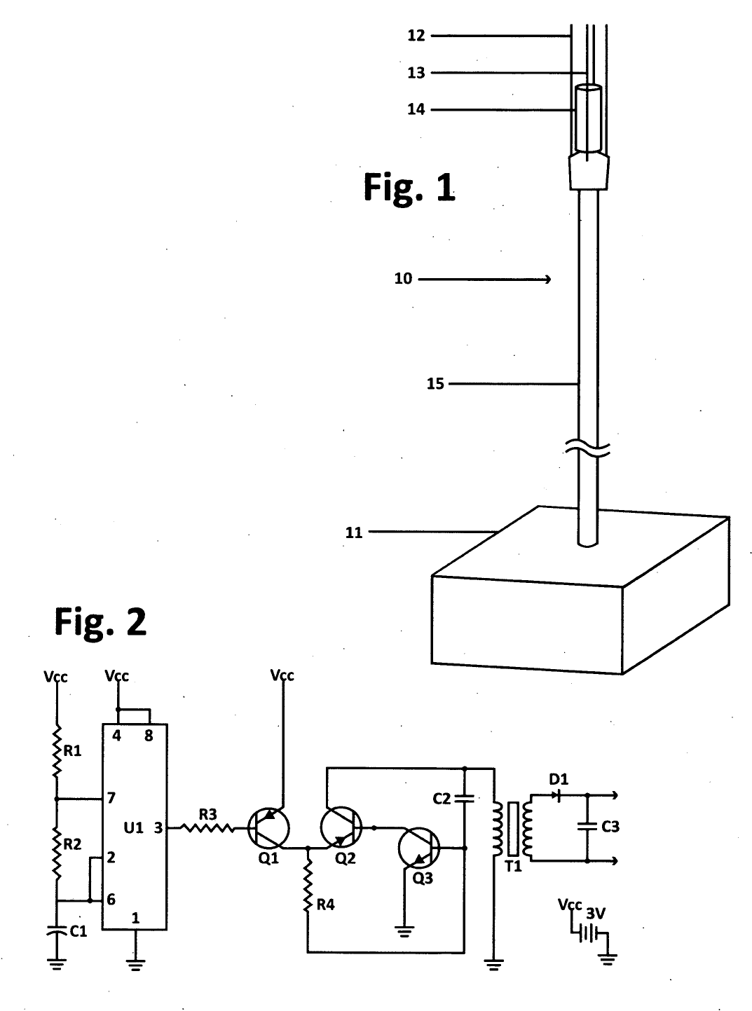

FIG. 1 shows a perspective view of a typical embodiment.

FIG. 2 shows a schematic drawing of a circuit and electronic components that can be used in this type of device.

### DESCRIPTION OF A TYPICAL EMBODIMENT

FIG. 1 shows an embodiment of a shock-producing deer repellent device 10 having a protective housing 11 enclosing a power supply and electronic components that maintain a predetermined voltage between straight, rigid, parallel, alternating positive electrodes 12 and negative electrodes 13. The four electrodes protrude vertically from the top of the device to surround the bait 14. The device has a stem 15 as support for the electrodes and the bait and to carry conductors from the electronics to the electrodes.

The housing and stem are made from UV-stabilized, PVC plastic. The device is about as tall as a deer's nose.

The electrodes are made from un-insulated stainless steel spring wire of sufficient diameter and rigidity to prevent easy distortion. In this embodiment the electrode diameter is about 0.045 inches.

The bait can be an artificial scent as available from Agilex Flavors and Fragrances, Piscataway, N.J., or it can be a natural compound such as peanut butter.

The alternating positive and negative electrodes are spaced close enough to ensure the deer will effectively contact both simultaneously, while being far enough apart to allow room for the bait and to avoid accidental contact between the electrodes. In this embodiment the four vertical electrodes are equally spaced around the bait describing a circle about one-half inch in diameter and with the positive and negative electrodes having about one-quarter inch between them.

The electrodes are of sufficient length to surround the bait but not so long that the ends can be pushed together easily. In this embodiment they are about one and a half inches long.

The electrodes are held vertically so that they cannot collect snow or ice and so water drains away quickly.

FIG. 2 shows a schematic of a circuit that can be used to charge capacitor, C3, to about 360 volts when the input voltage, Vcc, is about 3.1 volts, and when transformer, T1, has a primary/secondary winding ratio of 1/138 with 27 primary windings. T1 has a 20 milliwatt power rating in this circuit at 14 KHz. The values of the resistors are: R1=2.7 M, R2=10 K, R3=470 K, and R4=33 K. The values of the capacitors are: C1=470 uf, 10 volt, electrolytic; C2=0.047 uf, 10 volt, ceramic; and C3=1.5 uf, 400 volt, metalized polyester. The transistors Q1 and Q2 are 2N2907, and Q3 is a 2N2222. The diode, D1, is a 1N4006. The timer, U1, is a ICM7555CN. The circuit shown in FIG. 2, with these component values, will charge the capacitor for 3.26 seconds with an interval of 14.7 minutes between charging pulses. The charging time, the charging interval, the capacitance of C3 and the voltage to which C3 is charged, are all variable and can be adjusted by changing the circuit components. The power supply for this circuit is 2 AA batteries in series. All components are ¼ watt, and all components are readily available except transformer, T1, which is custom made for this application.

Accordingly, it can be seen that the combination of features incorporated into the embodiment of electrodes for a deer repellent device described herein has all the advantages of the prior art without the disadvantages, and it can be seen that this embodiment solves problems associated with the prior art electrode designs used on this type of device with new and unobvious results that have not been produced by the prior art.

The description of an embodiment of electrodes for a deer repellent device contained herein is an exemplification of typical embodiments and is considered as illustrative of principles only. Even though this description may contain various specificities, these should not be construed as limitations on the scope of this embodiment. The electrodes for a deer repellent device could be of varying lengths and diameters. The electrodes can have varying composition of different metals or other conductors. The electrodes can be other than straight and there could be varying numbers of electrodes. This device can operate with various charging circuits and at a wide range of voltages. The power supply can be batteries, solar power, or other power sources. Other changes in size, color, materials, shape, form, function, and manner of operation, assembly, and use, are deemed readily apparent and do not depart from the scope of this embodiment of electrodes for a deer repellent device that is limited only by the appended claims and their legal equivalents rather than by the examples given.

1. A deer repellent device, comprising:
a housing means containing a power supply and electronic components to maintain a predetermined voltage across a plurality of positive and negative, un-insulated, metal electrodes, and
support means for said electrodes and for bait provided to attract said deer to touch said electrodes of said device, said electrodes being substantially straight and substantially vertical, sized with a sufficient diameter to resist distortion and spaced to surround and protect said bait and to extend vertically above said bait

2. An animal repellent device, comprising:
an electrical housing;
a stem extending upwardly from the housing;
a bait supporting surface supported on the stem; and
a plurality of elongated electrodes supported from and positioned about a periphery of the bait supporting surface, the electrodes extending substantially vertically upwardly from the bait supporting surface.

3. The animal repellant device of claim 2, wherein the electrical housing includes a power source and a charging circuit, the charging circuit operable to charge at least every other one of the plurality of elongated electrodes to create a potential between the charged electrodes and a second set of electrodes.

4. The animal repellant device of claim 3, wherein the electrodes are positioned such that every charged electrode is positioned between at least two of the second set of electrodes and every one of the second set of electrodes is positioned adjacent a charged electrode.

5. The animal repellant device of claim 4, wherein the power source comprises solar power.

6. The animal repellant of claim 3, wherein the electrodes are sized and positioned to extend vertically above the bait supporting surface a sufficient distance to extend beyond the level of a bait.

7. The animal repellant device of claim 6, wherein the electrodes comprise stainless steel spring wire.

8. The animal repellant device of claim 3, further comprising a plurality of conductors extending from the electrical housing through the stem to the electrodes.

9. An animal repellant device, comprising:
a bait supporting surface,
a plurality first electrodes having a first charge positioned about a periphery of the bait supporting surface, the first electrodes extending substantially vertically upwardly from the bait supporting surface, and
a plurality of second electrodes having a second charge different from the first charge such that there is a potential between the first and second electrodes, the second electrodes positioned about the periphery of the bait supporting surface with each second electrode positioned adjacent a first electrode so that there is a potential between every adjacent pair of electrodes.

10. The animal repellant device of claim 9, wherein the first electrodes are positively charged and the second electrodes are negatively charged.

11. The animal repellant device of claim 10, wherein the electrodes are positioned to be spaced apart from a bait supported on the bait supporting surface.

12. The animal repellant device of claim 10, wherein the electrodes comprise a stainless steel spring wire.

13. The animal repellant device of claim 12, wherein the animal repellant further comprises a bait, wherein the electrodes are positioned to be spaced apart from the bait and to extend vertically above the highest level of the bait.

14. The animal repellant device of claim 13, wherein the animal repellant device further comprises an electrical housing, an electrical charging circuit enclosed in the housing, and wherein the electrodes are spaced apart from the electrical housing.

15. The animal repellant device of claim 14, wherein the animal repellant device is solar powered.
